(19) United States
(12) Patent Application Publication
(10) Pub. No.: US 2011/0132934 A1
(43) Pub. Date: Jun. 9, 2011

(54) Hydraulic Dispenser Apparatus

(76) Inventor: Jorge G. Normandia, Caguas, PR (US)

(21) Appl. No.: 12/631,819

(22) Filed: Dec. 5, 2009

(51) Int. Cl. B67D 7/60; B67D 7/64

(52) U.S. Cl. 222/334

(57) ABSTRACT

Here presented is a hydraulic dispensing apparatus that includes a main frame as a base 1, said frame 1 having a reservoir 4 for liquids for dispensing joined to a cylinder 2 and piston 3 structure fastened to it. The frame 1 provides a hose connector 8 to accept the intake of hydraulic fluids into the cylinder 2 and piston 3 structures; this would provide hydraulic force to actuate the piston 3. Said cylinder 2 has a hose connector 12 to accept the intake of liquids for dispensing from the reservoir 4. This connection allows the cylinder 2 to be refilled without having one of the ends of the cylinder 2 opened. A piston rod 7, secured to the piston 3 and movable therewith, allows for the piston 3 to be retracted to its initial position either manually or with the use of a mechanical device. Retracting the piston 3 to its initial position creates a vacuum effect that forces the liquids for dispensing from the reservoir 4 into the cylinder 2.

### BACKGROUND OF THE INVENTION

1. Field of the Invention

The present invention relates to devices for dispensing of liquids such as, but not limited to, cleaning solutions. More particularly to devices that can be used as a single device or as components of an automated system that can dispense liquids over surfaces.

2. Description of Related Art

It is known to provide devices that can dispense liquids such as, cleaning solutions, on to surfaces that can be used as a single device or as a component of an automated system. These devices can use air pumps to actuate a piston or the use of liquids such as, water, to mix this liquid with the liquids for dispensing in the case of some handheld devices and many automated systems such as, automated car wash systems. There are also other hydraulic dispensers that use hydraulic pressure to actuate a piston that would collapse a recipient containing the liquids for dispensing, but these uses separated components such as additional pistons and arms connected to the pistons to operate the entire system.

Inherent shortcomings with these devices includes the constant inconvenience of pumping the device to create air pressure to dispense liquids or that the liquids for dispensing are inaudibly mixed with other liquids such as, water. This last is inconvenient because there are liquids that are effective only if diluted on a measurable basis not in an uncontrollable mixture of liquids, also because it makes the devices use excessive amounts of liquids such as, water. In the case of other hydraulic dispensers, the use of different components such separated hydraulic cylinders with a first and second pistons connected to each other with an arm, that would use hydraulic pressure to actuate the second piston, that would force the liquids for dispensing out of their reservoir, and retract said second piston with hydraulic pressure applied to the first piston on a separated cylinder to its initial position. This creates a problem for the user since the user must carry and operated multiple components to use these hydraulic dispenser and for an automated system because it promotes a costly operation of the system. There is the need for a device that can be used both as a single device or as a component of an automated system that can enable the use of either diluted or undiluted liquids for dispensing without risking unmeasured mixing of the liquids, does not need excessive amounts of liquids such as, water, without the constant pumping of air to the device to operate and without the problem of multiple components to carry and operate.

### OBJECT AND SUMMARY OF THE INVENTION

It is an object of the present invention to overcome these and other shortcomings of the prior art mentioned above. These and other objects are achieved by the present invention described herein.

The present invention achieves these and other objectives by providing a liquids dispenser that operates a single unit, said dispenser uses a piston 3 that when hydraulic pressure is applied, it will in turn create pressure on the liquids for dispensing forcing them out of the housing. This piston 3 is the component of the invention that allows a user to enjoy the smooth operation of hydraulic pressure instead of the manual air pump and at the same time allowing the user to dilute the liquids for dispensing in a measurable basis without risking any mixtures with the hydraulic liquids.

The preferred embodiment of this invention includes a main frame as a base 1, said frame 1 having a reservoir 4 for liquids for dispensing joined to a cylinder 2 and piston 3 structure fastened to it. The frame 1 provides a hose connector 8 to accept the intake of hydraulic fluids into the cylinder 2 and piston 3 structures; this would provide hydraulic force to actuate the piston 3. Said cylinder 2 has a hose connector 12 to accept the intake of liquids for dispensing from the reservoir 4. This connection allows the cylinder 2 to be refilled without having one of the ends of the cylinder 2 opened. A piston rod 7, secured to the piston 3 and movable therewith, allows for the piston 3 be retracted to its initial position either manually or with the use of a mechanical device. Retracting the piston 3 to its initial position creates a vacuum effect that forces the liquids for dispensing from the reservoir 4 into the cylinder 2. Said frame 1 has a push/pull rod with a handle 5 to enable a user to push the piston 3 to its initial position to enable a new cycle of dispensing. Said cylinder 2 has apertures 11 on the hydraulic fluids intake end of it that allows for the release of hydraulic pressure to enable a user to retract the piston 3 to its initial position. Said apertures 11 are seal able with seals 6 fixed to the end of the push/pull rod 5. Said pus/pull rod 5 has a fork 6 like member fixed to the end of it, this member when the push/pull rod 5 is pushed it attaches to the piston rod 7. Said fork like member 6 has the seals 6 that seal the cylinder 2 and piston 3 structure fixed to it.

### BRIEF DESCRIPTION OF THE DRAWINGS

The present invention is more fully understood by reference to the following detailed description of an illustrative embodiment with the drawings identified below.

FIG. 1 is a perspective view of the liquids dispenser in accordance with the preferred embodiment of the invention.

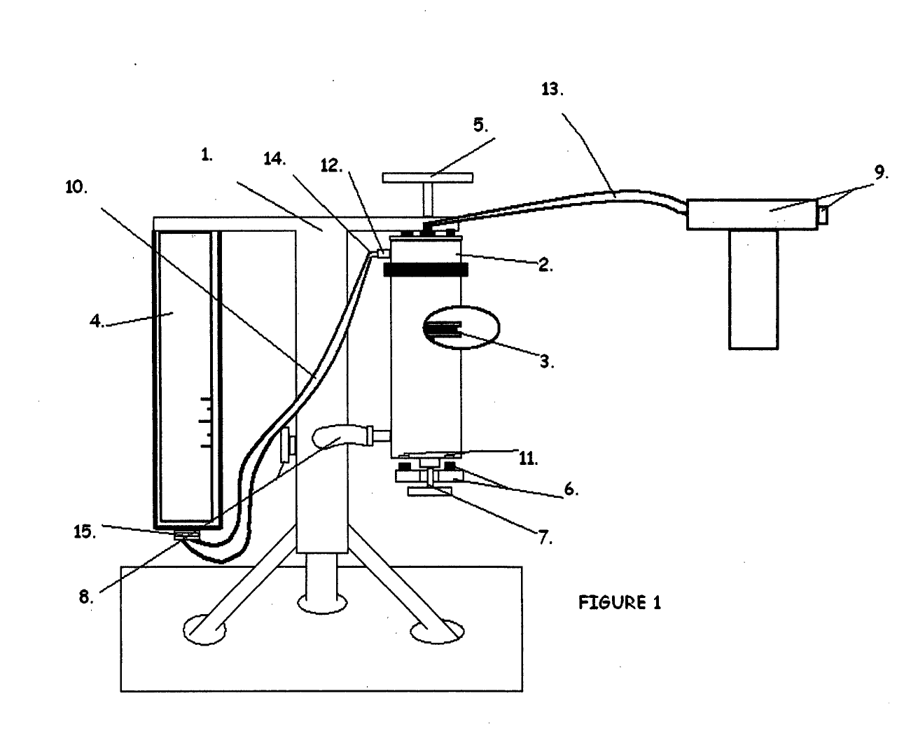

### DETAILED DESCRIPTION OF THE INVENTION

Here presented is a hydraulic dispensing apparatus that includes a main frame as a base 1, said frame 1 having a reservoir 4 for liquids for dispensing joined to a cylinder 2 and piston 3 structures fastened to it. The frame 1 provides a hose connector 8 to accept the intake of hydraulic fluids into the cylinder 2 and piston 3 structures; this would provide hydraulic force to actuate the piston 3. Said cylinder 2 has a hose connector 12 to accept the intake of liquids for dispensing from the reservoir 4. This connection allows the cylinder 2 to be refilled without having one of the ends of the cylinder 2 opened. A piston rod 7, secured to the piston 3 and movable therewith, allows for the piston 3 be retracted to its initial position either manually or with the use of a mechanical device. Retracting the piston 3 to its initial position creates a vacuum effect that forces the liquids for dispensing from the reservoir 4 into the cylinder 2. to avoid back flow of liquids for dispensing into the reservoir 4, a check valve 14 can be used. Said frame 1 has a push/pull rod with a handle 5 to enable a user to push the piston 3 to its initial position to enable a new cycle of dispensing. Said cylinder 2 has apertures 11 on the hydraulic fluids intake end of it that allows for the release of hydraulic pressure to enable a user to retract the piston 3 to its initial position. Said apertures 11 are seal able with seals 6 fixed to the end of the push/pull rod 5. Said pus/pull rod 5 has a fork 6 like member fixed to the end of it, this member when the push/pull rod 5 is pushed it attaches to the piston rod 7. Said fork like member 6 has the seals 6 that seal the cylinder 2 and piston 3 structure fixed to it.

The way the apparatus works is as follows; the user connects the apparatus to a source of hydraulic fluids such as, but not limited to, a house hold faucet, the hydraulic fluids will cause hydraulic pressure that actuates the piston 3 inside the cylinder 2 structure. When the cylinder 2 structure is filled with the liquids to be dispensed such as, but not limited to, cleaning solutions, the actuated piston 3 will create the force to force the liquids being dispensed out of the cylinder 2 structure thru the opposite end of the hydraulic fluid intake and thru a hose 13 connected to a handle with a valve and nozzle assembly 9. The apparatus could use check valves 14 on the dispensing end of the cylinder 2 and piston 3 structures to avoid any liquids being dispensed to flow back to the reservoir 4. Said handle with a valve and nozzle assembly 9 would be used as a flow rate controller since the piston 3 inside the cylinder 2 will be exerting constant pressure to expel the liquids being dispensed. The reason to have the piston 3 exerting constant pressure and having the flow rate controller in the handle 9 is to avoid excess dispense of liquids. When the push/pull rod 5 is actuated, the fork 6 at its end attaches to the piston rod 7 an retracts the piston 2 while it removes the seals 6 from the apertures 11 thus enables hydraulic force to be released, when the push/pull rod 5 is pull to its initial position the user lock it in place to keep the seals 6 secured and the cylinder 2 structure sealed.

The reservoir 4 is removable and refillable to enable the user to change the liquids being dispensed. A slide able reservoir is use to store liquids for dispensing. This reservoir can be slide into the frame 1 and connected to a hose 10, that connects the reservoir 4 and the cylinder 2 and piston 3 structures, using a quick connect coupling.

What is claimed is:

1. A hydraulic dispensing apparatus that includes a main frame as a base 1, said frame 1 having a reservoir 4 for liquids for dispensing joined by a hose 10 to a cylinder 2 and piston 3 structure, that are fastened to the frame 1, and a hose connector 8 to accept the intake of hydraulic fluids into the cylinder 2 and piston 3 structures.

2. Said piston 2 has a piston rod 7, secured to the piston 3 and movable therewith, that allows for the piston 3 be retracted to its initial position either manually or with the use of a mechanical device, retracting the piston 3 to its initial position creates a vacuum effect that forces the liquids for dispensing from the reservoir 4 into the cylinder 2.

3. Said frame 1 has a push/pull rod with a handle 5 that, when pushed, enables a user to push the piston 3 to its initial position to enable a new cycle of dispensing and when said rod 5 is pulled and secured in position seals said cylinder 2.

4. Said push/pull rod 5 has a fork 6 like member fixed to the end of it, this member when the push/pull rod 5 is pushed it attaches to the piston rod 7 this fork like member 6 has the seals 6, that seal the cylinder 2 and piston 3 structures, fixed to it.

5. Said cylinder 2 has apertures 11 on the hydraulic fluids intake end of it that allows for the release of hydraulic pressure to enable a user to retract the piston 3 to its initial position, this apertures 11 are seal able with seals 6 fixed to fork like member 6 at the end of the push/pull rod 5.
